(19) United States
(12) Patent Application Publication
(10) Pub. No.: US 2006/0245669 A1
(43) Pub. Date: Nov. 2, 2006

(54) Information processing apparatus and image processing circuit

(75) Inventor: Eiki Obara, Hiki-gun (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/364,150

(22) Filed: Feb. 27, 2006

(30) Foreign Application Priority Data
Apr. 28, 2005 (JP) 2005-133193

(51) Int. Cl. G06K 9/36

(52) U.S. Cl. 382/276

(57) ABSTRACT

According to one embodiment, a plurality of predetermined operation coefficients are stored in operation coefficient storage area, operation coefficients corresponding to a plurality of input pixel signals are fetched from the operation coefficient storage area, a new pixel is generated and output as an output pixel signal.

### CROSS-REFERENCE TO RELATED APPLICATIONS

This application is based upon and claims the benefit of priority from Japanese Patent Application No. 2005-133193, filed Apr. 28, 2005, the entire contents of which are incorporated herein by reference.

### BACKGROUND

1. Field

One embodiment of the invention relates to an image processing technique of, for example, a personal computer and digital television and, more particularly, to an information processing apparatus and image processing circuit capable of increasing the number of pixels of an input image signal by image interpolation.

2. Description of the Related Art

In the prior art of image processing for increasing the number of pixels of an input image signal by image interpolation, the number of pixels of an input image signal has been increased by pixel interpolation, irrespective of magnitude of the input signal (pixel) (see, for example, Jpn. Pat. Appln. KOKAI Publication No. 2000-148061 and Jpn. Pat. Appln. KOKAI Publication No. 2000-308021).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an illustration showing a notebook-size personal computer as an information processing apparatus according to a first embodiment of the invention;

FIG. 2 is a block diagram showing a system configuration of the system according to the first embodiment;

FIG. 3 is a block diagram showing a structure of a graphics controller to which an image processing circuit according to the embodiment of the present invention is applied according to the first embodiment; and

FIG. 4 is an illustration showing positional relationship between pixels of input image signals and pixels of output image signals according to a second embodiment of the invention.

### DETAILED DESCRIPTION

Various embodiments according to the invention will be described hereinafter with reference to the accompanying drawings. In general, according to one embodiment of the invention, an image processing circuit configured to increase number of pixels of an input image signal by image interpolation. The image processing circuit comprises storage means for storing a plurality of predetermined operation coefficients, and generation means for fetching the operation coefficients corresponding to a plurality of input pixel signals from the storage means, creating a new image and outputting the new image as an output pixel signal.

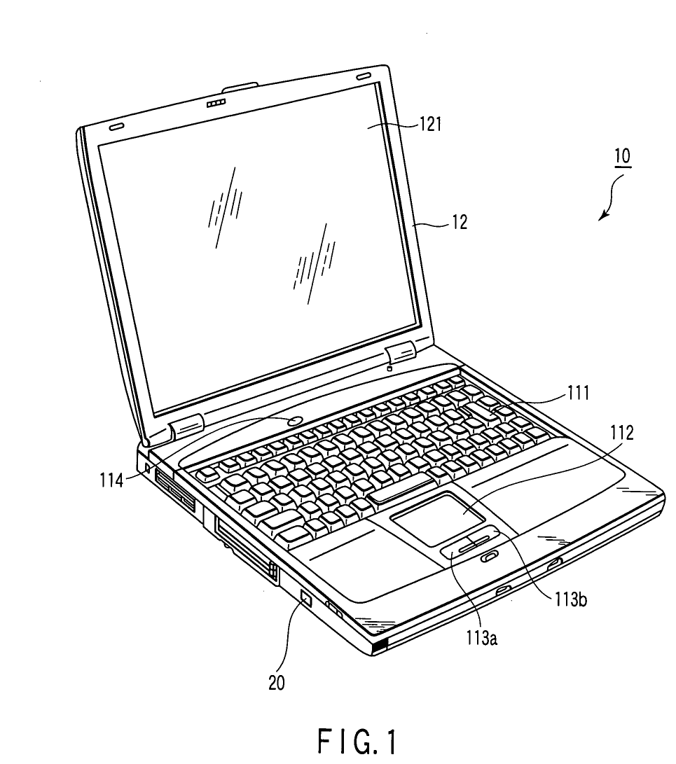

According to an embodiment, FIG. 1 is an illustration showing a notebook-size personal computer as an information processing apparatus according to an embodiment of the present invention.

A computer 10 comprises a main body and a display unit 12. A display device composed of an LCD (Liquid Crystal Display) is embedded in the display unit 12. A display screen 121 of the LCD is arranged at a substantially central position of the display unit 12.

The display unit 12 is attached to the computer 10 to freely pivot between an opened position and a closed position. A main body of the computer 10 is a housing shaped in a thin box. A power button 114 and a keyboard 111 are arranged on the housing. A touch pad 112 and right and left buttons 113a, 113b are arranged on a palm rest. An optical disk drive and the like are arranged under the palm rest.

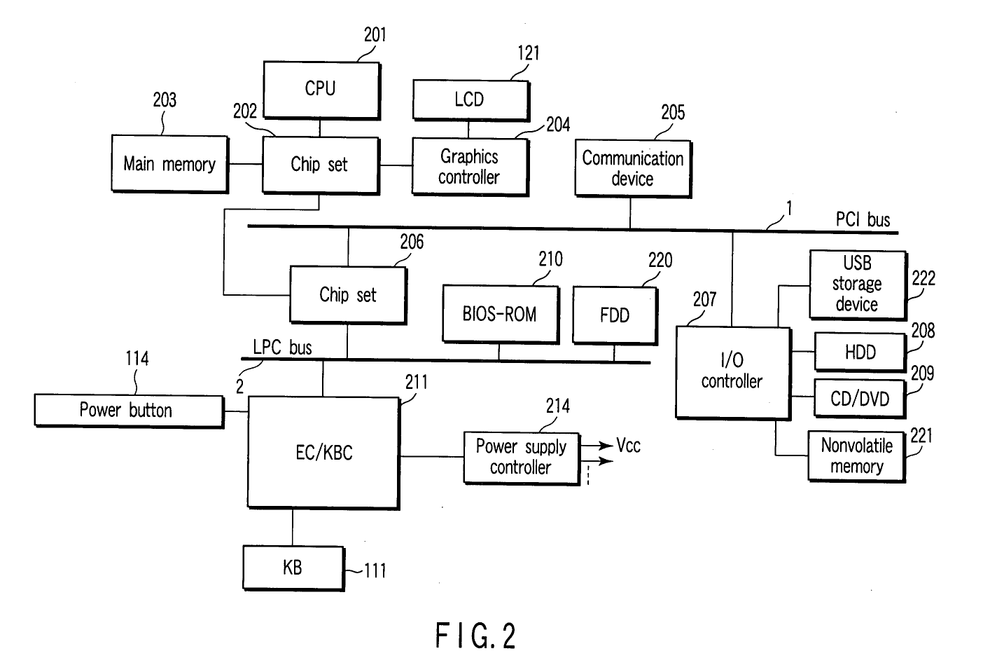

FIG. 2 is a block diagram showing a system configuration of the computer 10.

The computer 10 comprises a CPU 201, a chip set 202, a main memory 203, a graphics controller 204, a communication device 205, a chip set 206, an I/O controller 207, a hard disk drive (HDD) 208, a CD/DVD drive 209, a BIOS-ROM 210, an embedded controller/keyboard controller IC (EC/KBC) 211 and the like.

The CPU 201 is a processor provided to control operations of the computer 10. The CPU 201 executes an operating system (operation system) and an application program/utility program loaded into the main memory 203 by the hard disk drive (HDD) 208. In addition, the CPU 201 also executes the BIOS (Basic Input Output System) stored in the BIOS-ROM 210.

The chip set 202 is a bridge device which makes bidirectional connection between a local bus of the CPU 201 and an LPC bus 2. The graphics controller 204 controls the LCD display screen 121 employed as a display monitor of the computer 10. The communication device 205 is one of PCI devices and is employed for connection to, for example, a computer network such as the Internet. The I/O controller 207 is also one of PCI devices. An IDE controller and the like are built in the I/O controller 207 to control the hard disk drive (HDD) 208, a CD/DVD drive 209.

The chip set 206 is a bridge device which makes bidirectional connection between a PCI bus 1 and the LPC bus 2. Various kinds of system devices such as a system timer, a DMA controller, an interrupt controller and the like are built in the chip set 206.

The EC/KBC 211 is a one-chip microcomputer in which an embedded controller for power management and a keyboard controller for controlling the keyboard 111 are integrated.

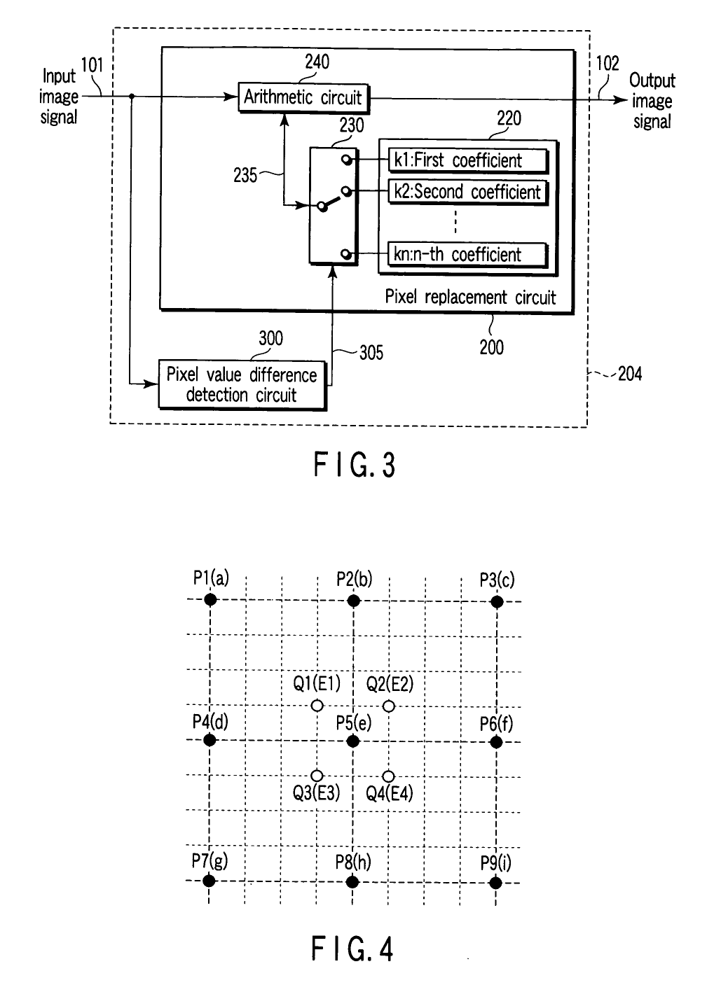

FIG. 3 is a block diagram showing a structure of a graphics controller to which an image processing circuit according to the embodiment of the present invention is applied.

The graphics controller 204 is composed of a pixel value difference detection circuit 300 for detecting a pixel value difference of a value between adjacent horizontal pixels and a value between adjacent vertical pixels, from input pixel information of an input image signal 101 output from the chip set 202, and a pixel replacement circuit 200 for executing a predetermined operation of the input pixel information of an input image signal 101 output from the chip set 202 and outputting the input pixel information to the LCD 121 as an output image signal including an output pixel signal.

The pixel replacement circuit 200 is composed of an operation coefficient storage area 220 in which a plurality of predetermined operation coefficients k1, k2, . . . and kn are stored, a coefficient changing switch 230 for receiving a changing signal corresponding to the detected differential value from the pixel value difference detection circuit 300 and changing the coefficient to the corresponding operation coefficient, and an arithmetic circuit 240 for receiving a predetermined operation coefficient from the coefficient changing switch 230 and executing a pixel replacement processing to increase pixels on the basis of the predetermined operation coefficient and the input pixel information of the input image signal 101 output from the chip set 202.

Next, the pixel replacement processing executed by the graphics controller 204 will be explained.

The input pixel information of the input image signal 101 which is output from the chip set 202 is input to the pixel value difference detection circuit 300.

The pixel value difference detection circuit 300 detects a difference value of a value between adjacent horizontal pixels and a value between adjacent vertical pixels, and supplies the detected difference value to the coefficient changing switch 230 as a coefficient changing signal.

On the other hand, the input image signal 101 input to the arithmetic circuit 240 of the pixel replacement circuit 200 is subjected to pixel replacement by the pixel replacement circuit 200. In the pixel replacement, operation coefficients k1, k2, kn stored in the operation coefficient storage area 240 are fetched therefrom by changing the input image signal 101 to the corresponding operation coefficient by the coefficient changing switch 230, the input pixel signal of the input image signal is subjected to the pixel replacement using the operation coefficients by the arithmetic circuit 240, and the output pixel signal is output as an output image signal 102. If a new pixel is created, the operation coefficients are arranged close to the pixel value of the closest pixel.

Needless to say, the above-described function can also be implemented in the following structure, i.e., software processing including the CPU 201, the main memory 203 and the chip set 202.

FIG. 4 shows an illustration showing positional relationship between pixels of input image signals and pixels of output image signals. Pixel values are expressed in parentheses.

P1-P9 represent (positions of) input pixels of the input image signals, a−i represent pixel values of input pixels P1-P9, and Q1-Q4 represent interpolated pixels.

First, when P5 is referred to as a pixel of interest, interpolated pixels Q1-Q4 represent positions of four pixels formed around the pixel of interest PS. The pixel of the pixel of interest P5 is replaced with pixels of the interpolated pixels Q1-Q4 by the operation.

E1-E4 represent pixel values of the interpolated pixels Q1-Q4. Samples of the pixel values E1-E4 formed by the operation are expressed below.
E1=(8e+kx(a−i))/8
E2=(8e+kx(c−g))/8
E3=(8e+kx(g−c))/8
E4=(8e+kx(i−a))/8

kx is a coefficient (operation coefficient) determined on the basis of a differential value detected by the pixel value difference detection circuit 300, which is equal to or greater than zero, i.e. any value of k1-kn (n: natural number). The operation coefficient is obtained in the following manner:

(Manner of Obtaining the Operation Coefficient)
Coefficient of E1:kx=β((n−x)/n)
where 2^{m}(x/n)>|e−a|≧2^{m}((x−1)/n)
Coefficient of E2:kx=β((n−x)/n)
where 2^{m}(x/n)>|e−c|≧2^{m}((x−1)/n)
Coefficient of E3:kx=β((n−x)/n)
where 2^{m}(x/n)>|e−g|≧2^{m}((x−1)/n)
Coefficient of E4:kx=β((n−x)/n)
where 2^{m}(x/n)>|e−i|≧2^{m}((x−1)/n)

‘m’ of 2m represents the quantization number of the digital processing. m is eight in the 8-bit processing. ‘x’ represents a value in a range of 1 to n. ‘β’ represents a coefficient which is arbitrarily set in a range of, for example, 0.1 to 1.

As for the other examples of the pixel values to be replaced, they can also be obtained in the following manners while referring to a number of peripheral pixel information items:
E1=((N−2)e+2kx·e+kx((a+b+d)−(c+f+g+h+i)))/(N−2)
E2=((N−2)e+2kx·e+kx((b+c+f)−(a+d+g+h+i)))/(N−2)
E3=((N−2)e+2kx·e+kx((d+g+h)−(a+b+c+f+i)))/(N−2)
E4=((N−2)e+2kx·e+kx((f+h+i)−(a+b+c+d+g)))/(N−2)

where N is an integer equal to or greater than 3 and kx is equal to or greater than 0.

If the pixel vale of the input signal is greatly varied, the operation coefficient in the case of crating a new pixel on the basis of a plurality of pixels is set to be close to the pixel value of the pixel which is positionally closest to the new pixel. For this reason, occurrence of unnatural phenomena can be restricted when the variation in the pixel value is great. In other words, even if the pixel vale of the input signal is greatly varied, natural images can be displayed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing circuit configured to increase number of pixels of an input image signal by image interpolation, comprising:
storage means for storing a plurality of predetermined operation coefficients; and
generation means for fetching the operation coefficients corresponding to a plurality of input pixel signals from the storage means, creating a new image and outputting the new image as an output pixel signal.

2. An image processing circuit configured to increase number of pixels of an input image signal by image interpolation and output the image signal as an output signal, comprising:
pixel value difference detection means for detecting a pixel value difference from the image signal;
storage means for storing a plurality of predetermined operation coefficients; and
generation means for fetching the operation coefficient corresponding to the image signal, of the operation coefficients stored in the pixel value difference detection means, and creating a new image as an output pixel signal, on the basis of the pixel value difference signal detected by the pixel value difference detection means and the plurality of pixel signals.

3. The image processing circuit according to claim 1, wherein in an image in which a sampling frequency is an integer multiple of a line frequency, interpolation is executed to acquire a pixel value of an interpolation pixel in a straight line which links two proximate pixels arranged on most proximate position in an oblique direction sandwiching a pixel of interest, as an average of pixel values of the pixel of interest and the proximate pixels;
an interpolation position of the interpolation pixel is set at a position which is a quarter of a distance between the pixel of interest and the proximate pixels, four of the interpolation pixels are generated around the pixel of interest, the interpolation pixels are used instead of the pixel of interest and the proximate pixels, and number of pixels in a horizontal direction and a vertical direction of an original image is thereby doubled; and
if the pixel value of the pixel of interest is e and pixel data of four of the proximate pixels arranged around the pixel of interest are a, c, g, i in order along a circumferential direction, pixel values E1, E2, E3, E4 of the interpolation pixels are
E1=(αe+kx(a−i))/α,
E2=(αe+kx(c−g))/α,
E3=(αe+kx(g−c))/α,
E4=(αe+kx(i−a))/α,
where kx is any one of the operation coefficients k1 to kn that is equal to or greater than zero, and α and n are natural numbers.

4. The image processing circuit according to claim 2, wherein in an image in which a sampling frequency is an integer multiple of a line frequency, interpolation is executed to acquire a pixel value of an interpolation pixel in a straight line which links two proximate pixels arranged on most proximate position in an oblique direction sandwiching a pixel of interest, as an average of pixel values of the pixel of interest and the proximate pixels;
an interpolation position of the interpolation pixel is set at a position which is a quarter of a distance between the pixel of interest and the proximate pixels, four of the interpolation pixels are generated around the pixel of interest, the interpolation pixels are used instead of the pixel of interest and the proximate pixels, and number of pixels in a horizontal direction and a vertical direction of an original image is thereby doubled; and
if the pixel value of the pixel of interest is e and pixel data of four of the proximate pixels arranged around the pixel of interest are a, c, g, i in order along a circumferential direction, pixel values E1, E2, E3, E4 of the interpolation pixels are
E1=(αe+kx(a−i))/α,
E2=(αe+kx(c−g))/α,
E3=(αe+kx(g−c))/α,
E4=(αe+kx(i−a))/α,
where kx is any one of the operation coefficients k1 to kn that is equal to or greater than zero, and α and n are natural numbers.

5. The image processing circuit according to claim 1, wherein the operation coefficients are arranged close to a pixel value of a positionally closest pixel.

6. The image processing circuit according to claim 2, wherein the operation coefficients are arranged close to a pixel value of a positionally closest pixel.

7. An information processing apparatus comprising an image processing circuit configured to increase number of pixels of an input image signal by image interpolation,
the image processing circuit comprising:
storage means for storing a plurality of predetermined operation coefficients; and
generation means for fetching the operation coefficients corresponding to a plurality of input pixel signals from the storage means, creating a new image and outputting the new image as an output pixel signal.

8. An information processing apparatus comprising an image processing circuit configured to increase number of pixels of an input image signal by image interpolation,
the image processing circuit comprising:
pixel value difference detection means for detecting a pixel value difference from the image signal;
storage means for storing a plurality of predetermined operation coefficients; and
generation means for fetching the operation coefficient corresponding to the image signal, of the operation coefficients stored in the pixel value difference detection means, and creating a new image as an output pixel signal, on the basis of the pixel value difference signal detected by the pixel value difference detection means and the plurality of pixel signals.

9. The information processing apparatus according to claim 7, wherein in an image in which a sampling frequency is an integer multiple of a line frequency, interpolation is executed to acquire a pixel value of an interpolation pixel in a straight line which links two proximate pixels arranged on most proximate position in an oblique direction sandwiching a pixel of interest, as an average of pixel values of the pixel of interest and the proximate pixels;
an interpolation position of the interpolation pixel is set at a position which is a quarter of a distance between the pixel of interest and the proximate pixels, four of the interpolation pixels are generated around the pixel of interest, the interpolation pixels are used instead of the pixel of interest and the proximate pixels, and number of pixels in a horizontal direction and a vertical direction of an original image is thereby doubled; and
if the pixel value of the pixel of interest is e and pixel data of four of the proximate pixels arranged around the pixel of interest are a, c, g, i in order along a circumferential direction, pixel values E1, E2, E3, E4 of the interpolation pixels are
E1=(αe+kx(a−i))/α,
E2=(αe+kx(c−g))/α,
E3=(αe+kx(g−c))/α,
E4=(αe+kx(i−a))/α,
where kx is any one of the operation coefficients k1 to kn that is equal to or greater than zero, and α and n are natural numbers.

10. The information processing apparatus according to claim 8, wherein in an image in which a sampling frequency is an integer multiple of a line frequency, interpolation is executed to acquire a pixel value of an interpolation pixel in a straight line which links two proximate pixels arranged on most proximate position in an oblique direction sandwiching a pixel of interest, as an average of pixel values of the pixel of interest and the proximate pixels;
an interpolation position of the interpolation pixel is set at a position which is a quarter of a distance between the pixel of interest and the proximate pixels, four of the interpolation pixels are generated around the pixel of interest, the interpolation pixels are used instead of the pixel of interest and the proximate pixels, and number of pixels in a horizontal direction and a vertical direction of an original image is thereby doubled; and
if the pixel value of the pixel of interest is e and pixel data of four of the proximate pixels arranged around the pixel of interest are a, c, g, i in order along a circumferential direction, pixel values E1, E2, E3, E4 of the interpolation pixels are
E1=(αe+kx(a−i))/α,
E2=(αe+kx(c−g))/α,
E3=(αe+kx(g−c))/α,
E4=(αe+kx(i−a))/α,
where kx is any one of the operation coefficients k1 to kn that is equal to or greater than zero, and α and n are natural numbers.

11. The information processing apparatus according to claim 7, wherein the operation coefficients are arranged close to a pixel value of a positionally closest pixel.

12. The information processing apparatus according to claim 8, wherein the operation coefficients are arranged close to a pixel value of a positionally closest pixel.
